(19) United States
(12) Patent Application Publication
(10) Pub. No.: US 2016/0012671 A1
(43) Pub. Date: Jan. 14, 2016

(54) Systems and Methods for Dice Elimination Games

(71) Applicant: Bruce Alsip, Seattle, WA (US)

(72) Inventor: Bruce Alsip, Seattle, WA (US)

(21) Appl. No.: 14/704,781

(22) Filed: May 5, 2015

Related U.S. Application Data
(60) Provisional application No. 61/992,018, filed on May 12, 2014.
(60) Provisional application No. 61/990,573, filed on May 8, 2014.
(60) Provisional application No. 61/990,563, filed on May 8, 2014.

(51) Int. Cl. G07F 17/32

(52) U.S. Cl. CPC G07F 17/3227; G07F 17/3286; G07F 17/3209; G07F 17/3267; G07F 17/322; G07F 17/3211

(57) ABSTRACT

A gaming system for playing a dice game of elimination, where plays are electronically scored on a virtual gameboard and user interface. Players begin by rolling several virtual dice at one time, and as the game advances to higher scoring levels, receive limited chances to throw two dice or a special die. Points on the gameboard are awarded to the player when the dice face value(s) as rolled equal one or more of the numbered open positions on the gameboard, eliminating those positions from further play. The game ends when no further play is possible. Rules are stored in non-volatile memory and are configured to be executed automatically by a processor of the gaming system. Automating game administration enhances fun, momentum in play, and encourages participation of a broader gaming community. The gaming system is manifested in on-line, mobile device, gaming machine, and other computing device embodiments.

### CROSS-REFERENCES TO RELATED APPLICATIONS

This application claims the benefit of U.S. Provisional Pat. Appl. Ser. No. 61/992018 titled “Electronic Gaming Machine for Dice Game of Elimination” filed 12 May 2014; U.S. Provisional Patent Appl. Ser. No. 61/990563 titled, “Gaming Machine, Apparatus and Methods of Gaming” filed 8 May 2014; and U.S. Provisional Pat. Appl. Ser. No. 61/990573 titled “Gaming Machine, Apparatus and Methods of Electronic Gaming with Virtual Dice” filed 8 May 2014, which are all incorporated herein in full by reference for all purposes.

### FIELD OF THE INVENTION

The present invention relates generally to digital gaming systems for operating games played with virtual dice.

### GOVERNMENT SUPPORT

The inventive matter disclosed herein was realized without government support.

### BACKGROUND

Digital gaming is a burgeoning industry. Electronic games are increasingly played everywhere—on mobile devices while en route to work, at home with friends, on social network websites, and in casinos. But there is a need for fresh content, more particularly games that are “sticky”, and once played, irresistibly attract further play. Conventional video games, slot machines, on-line casino gaming sites have had disappointing results in attracting the hoped for younger audiences because of the repetitive content.

Dice games have unrealized potential because they have been difficult to simulate and because they incorporate elements of strategy. A challenge remains in adapting the familiar dice cubes to an animated format for digital presentation. For example, “Shut the Box”, an old dice elimination game first played by seamen, has retained popularity for more than 800 years. Also called “Canoga” or “Klackers”, the game is played with two dice and a box with twelve scoring positions. However, the game is slow by modern standards, difficult to score, and was designed for multiple players.

The interest in new gaming systems is supported by cash flows linked to betting with credit, chips, or virtual currencies on-line and in casinos. As a rule of thumb, 10% of players prefer to gamble, sustaining new game development for 90% of players who enjoy the games on line without betting. This expanding market requires fresh approaches and innovation in digital gaming systems and games, approaches that result in new technical features or new combinations of technical features adapted to improve and increase the quality of fun in the playing, the experience of winning, and the participation of a broader gaming audience. Objects of the invention are to provide a solution to these and related problems.

### SUMMARY

Digitally automated dice games offering speed, ease in scoring, and convenience. A gaming system for virtual dice play, more particularly for playing a dice game of elimination, where plays are digitally scored on a gameboard and involve strategy. In a preferred embodiment, players begin by rolling several virtual dice, and, depending on their success at throwing fives and sixes, advance to throwing fewer dice at higher scoring levels. Dice may be scored as “naturals” or as “combinations”, where “natural” indicates the face up value of the dice as rolled, and “combinations” indicate an addition of two or more dice face values. Thus strategy and scoring become complex and benefit from computerized devices.

For positions on the gameboard that are “covered” (i.e., deleted or “eliminated”), the gaming system will credit the player, and the higher the numbered position(s) eliminated, the greater the payout, i.e., “points, “score” or dollars associated with the player's “selections” are awarded to the player. Each “open” numbered field may be selected only once, and the game is ended when a player rolls the dice but is unable to use all the dice face values (as rolled) to cover open positions on the gameboard. By careful strategy, the player can avoid a non-playable dice roll that results in a “trap state or condition”—and ends the game.

The games of the invention are more than just electronic versions of a traditional game. Whereas a conventional dice elimination game such as “Close the Box” used two solid dice cubes and a wooden box, and thus a player could roll only 36 possible combinations playable on a gameboard having 9 to 12 peg holes; in contrast, the inventive game has six dice and 36 selectable positions on a gameboard, resulting in almost uncountable combinations of play. In an exemplary dice elimination game of the invention, the gameboard is divided into three zones (ZONE ONE, ZONE TWO, and ZONE THREE), and offers higher scores as the player ascends from ZONE ONE, through ZONE TWO, all the way to ZONE THREE. To achieve the highest possible scoring levels, consistently high dice rolls are needed; thus the game associates with “high rollers”. The object of the game is to score as many points or chips as possible before playing into a “trap condition” (an end to scoring). Rolling high dice throws determines whether the player will advance or be trapped. Players who roll box cars are exhilarated; players who roll a series of snake eyes or deuces may see their chances fading. The game is fun and moves fast when played electronically.

When betting on a game outcome, a player begins by entering payment and starting play, but must first win back the bet value in order to come out ahead at the end of the game. Game outcomes are indeterminate but involve skill, so some players succeed at winning back their stake; some don't. With practice, higher scores are achieved. A leaderboard may be used for competitive matches. Computers manage these administrative functions and transform the player's selections into new game states.

For an electronic game at this level of complexity, a processor with programmable instructions is needed to generate each virtual dice roll, to receive a player's selections based on dice face values of the dice and open positions available for play, and to calculate scoring outcomes, the processor having a non-volatile memory sufficient to store a table of gameboard positions that have been eliminated as gameplay processes and, for updating the game state, an instruction set executable by the processor from non-volatile memory. A memory device is programmed with an initial game state and complex conditional loops forming the rules of the game. Also provided is a graphics rendering engine or daemon for displaying dice throws. In a simple version, the dice faces of the throw simply appear in a window; in more complex cases the dice are animated and roll across the game surface, coming to rest with dice faces up. A random number generator (RNG) is used to determine the outcome of the dice roll. In inexpensive systems, the random number generator is a pseudo-RNG function call in software. It is generally agreed that soft or canned RNG code functions are flawed and that conventional software randomization is not statistically valid. True random number generators (TRNGs) may also be used. In a preferred embodiment, a kinematic engine (kRNG) may be used to generate RNGs that are randomized by three-dimensional collisions and bounces as the virtual dice roll across a stage in virtual space. The implementation of three-dimensional ballistic kRNG technology brings a high level of realism and excitement to the game, because the player can see the winning dice faces tipping up before the computer can register them. This buildup in anticipation is a key element in any successful game.

A player can quickly advance to higher zones of the game by making higher dice rolls and selecting strategic selectable positions open on the gameboard. Advantageously, the computer blacks out or deletes the number of the position selected and adds a score to the player's total. The computer also aids in tracking scores and in ensuring each play follows the rules configured by the operator, allowing the player to concentrate on the game. With each dice throw, a significant combination of player skill and strategy is needed when making by making decisions about what numbered positions on the gameboard to eliminate. Skill in managing the elimination process is combined with chance (the luck of the dice roll) to produce endless variations in play. Advantageously, speed of play adds to fun, encourages momentum play, and results in higher returns to the game operator.

### BRIEF DESCRIPTION OF THE DRAWINGS

The teachings of the present invention are more readily understood by considering the drawings, in which:

FIG. 1A is a first overview of an exemplary gameboard. FIG. 1B is a display line on a gameboard for scoring rolls that are triples.

FIG. 2 is a schematic view of three zones of play and shows the number of dice that are rolled at each level.

FIG. 3 is a view of a high roll of three dice cubes.

FIG. 4 is a view of a high roll of two dice cubes.

FIG. 5 is a view of a high roll of a single dice cube.

FIG. 6 is a flow chart view showing a sample game algorithm used in programming a gaming system of the invention.

FIGS. 7A-7B are flow chart views showing a more complex sample game algorithm used in programming a gaming system of the invention.

FIG. 8 is a view of a gameboard having poor gaming characteristics.

FIG. 9 is a view of an improved gameboard having three zones and a triples line.

FIG. 10 is a view of a user interface of an exemplary gaming system of the invention as implemented on a mobile device.

FIG. 11 is a view of an exemplary casino gaming machine with a system of the invention.

FIG. 12 is a schematic showing functional elements of a gaming system of the invention.

FIGS. 13A, 13B and 13C are schematics of networked gaming systems in exemplary configurations.

FIG. 14 is a perspective view of a display of a stage in which tactile dice are thrown on a gameboard and are read by the gaming system electronically or optically.

FIG. 15 is a perspective sectional view of a dice cube, the section revealing an internal RFID antenna.

The drawing figures are not necessarily to scale. Certain features or components herein may be shown in somewhat schematic form and some details of conventional elements may not be shown in the interest of clarity, explanation, and conciseness.

### DEFINITIONS AND MEANINGS

Certain terms are used throughout the following description to refer to particular features, steps or components, and are used as terms of description and not of limitation. As one skilled in the art will appreciate, different persons may refer to the same feature, step or component by different names. Components, steps or features that differ in name but not in structure, function or action are considered equivalent and not distinguishable, and may be substituted herein without departure from the invention. Certain meanings are defined here as intended by the inventors, i.e., they are intrinsic meanings. Other words and phrases used herein take their meaning as consistent with usage as would be apparent to one skilled in the relevant arts. The following definitions supplement those set forth elsewhere in this specification.

“Gaming system”, also sometimes referred to here as a “gaming platform”, “gaming machine” or “gaming apparatus”, are generally digital electronic devices in part, and include at least one processor configured to execute digitally encoded instructions from non-volatile memory or embedded in firmware, random access memory for storing transient game data, wherein the system is configured to operate a user interface with display, attached peripherals, and system functions such as watchdog circuits. Individual devices may be networked as known in the art. Also typical are conventional features such as a bet acceptor and payout subsystem whereby winning players may receive awards according to conditional logic circuitry operated by the game system, often in conjunction with a network. Gaming systems of the invention may also include kinetic modelling circuitry or a software engine for graphical rendering, RNG circuitry or a software engine for random number generation, while not limited thereto.

Digitally-encoded instructions include software, software modules or routines, daemons, and structured logic gates known as firmware capable of being executed by a processor of a gaming system for operating a game or a function in support of a game. Firmware comprises of logic gates whereby a first digital state of a processor may be transformed into a second digital state of the processor, thereby digitally encoding an instruction.

In some gaming systems, an application specific integrated circuit (ASIC) may be used, limiting the requirement for software. Logic gates of the ASIC are digitally coupled to a processor so as to execute specialized functions based on a game state.

Characteristic of the systems are unique function calls to RNGs that are configured to operate with kinetic animation routines and to achieve randomness in game outcomes. Particularly preferred are hybrid games having features of lottery games with slot or dice configured in the form of a conceal-and-reveal game. Gaming machines may include computerized devices, including cellphones and mobile devices more generally when said computerized devices are capable of operating animated games of chance as independent devices or as part of networks, such as using a browser to access a website where a game is hosted. Preferred games of chance are interactive, and permit player input during the game. Betting may be optional in some systems.

“Computerized device” is used in a broad sense, and may include gaming systems having logic circuitry, at least one processor, a clock, non-transitory memory (such as ROM and EEPROM), transitory random access memory (including RAM and Z-RAM), and generally a clock, one or more ports to I/O devices such as a graphical user interface (including display), a pointer, a keypad, a sensor, firmware, a wireless or wired communications link, and so forth or firmware. Computers are frequently formed into networks, and networks of computers may also be referred to here by the terms “computing machine” or as components of a gaming platform or system. In one instance, informal internet networks known in the art as “cloud computing” may be functionally equivalent computing machines, for example. Computing machines also include mobile devices having processing capacity for running local applications (“apps”), browser-driven games, and/or cloud-based applications more generally.

A “server” refers to a software engine or to a computing machine on which a software engine runs, and provides a service or services to a client software program running on the same computer or on other computers distributed over a network. A client software program typically provides a user interface and performs some or all of the processing on data or files received from the server, but the server typically maintains the data and files and processes the data requests. A “client-server model” divides processing between clients and servers, and refers to an architecture of the system that can be co-localized on a single computing machine or can be distributed throughout a network or a cloud. Also used by servers are “application program interfaces” (API), including routines, protocols, and tools for building software applications. An API may specify how software components should interact and are used when programming graphical user interface (GUI) components such as for running an application.

“Processor” refers to a digital device that accepts information in digital form and manipulates it for a specific result based on logic circuitry and a sequence of logic instructions supplied as software or as firmware or as a combination thereof. Programmed or “programmable instructions” are generally stored as “computer code” in a non-transitory memory medium. Processor may also loosely refer to a CPU, a microcontroller or a microprocessor.

“Player interface”—a feature of a computing machine configured to convert a user signal such as a touch, selection, vocalization, or a gesture into a machine command or a response to a machine request for input. The interface is often associated with or part of a display operated by the computing machine to communicate with the player and will display and update a “game state” as play progresses.

Tactility—a feature having the quality of capable of being touched so as to evoke a response. Real dice may be termed “tactile dice” as used here.

Indicia—refer broadly to signs, indications, or distinctive markers displayed during a game which evoke special rules for playing, particularly in scoring wins and losses. Numbered positions or fields of a gameboard may be referred to as being marked by indicia, i.e., an indicium denoting the number of the position on the gameboard.

Iteration—defined here as a process wherein a set of instructions or structures are repeated in order a specified number of times or until a condition is met. When the first set of instructions is executed again, it is called an iteration. Variables accessed from memory in the process of iterating a sequence of instructions may be changed by each round of execution, thus resulting in a different outcome for each iteration.

Game of chance—any game played with an element of a bet or wager having either a cash value or an equivalent of a cash value. Considered here are those games where the game is played on a machine, generally an electronic gaming system or desktop computer, but also including portable devices such as cell phones and tablet computers, or played in an online venue, such as using a browser. Online venues may include applications downloaded from the internet or internet websites, and browser-driven play on websites configured for “social gambling” or “social gaming”.

Social gaming—an activity or practice of playing an online game, typically on a social media platform, with an emphasis on recruiting new players from friends and community. The definition includes games played as groups and also games played individually. In some instances winning is defined by a player's rank on a leaderboard. Examples include Bejeweled, Candy Crush, Hidden Object, Pota-Toss, TitanFall, Tetris, and typically contain user interactive audiovisual effects to stimulate casual enjoyment (as in “free to play” or downloaded for an at-home gamebox, for example). Game boxes include PLAYSTATION®, Xbox, Game Boy, and similar products. Some social games are learning games, others are competitions.

Social network gaming—an activity or practice of playing an online game through a social network, and while permitting asynchronous gameplay mechanics (i.e., players need not be simultaneously present in the game space), characteristically features multiplayer interactions. Reinforcement may involve cooperative problem solving and coordination of strategies to achieve favorable outcomes, essentially reinforcement based on shared bonds of community rather than on a single player “winning”. Examples include Kingdom Age, Words With Friends, Angry Birds, Settlers of Catan, and The Sims.

Social gambling—while traditionally defined as gambling among friends and associates in a private venue (where one of the direct participants will be the winner), the term has also come to encompass “online gambling” facilitated by gaming web sites (sometimes accessed through social media like Facebook), such as Zynga Poker, DoubleDown Interactive, IGT, Caesers-Playtika, Konami, Mikohn, Aruze, Hasbro, and Electronic Arts, as a partial list. Gambling for monetary prizes is permitted in some jurisdictions. Social gambling is defined as any game of chance played on a machine, whether computerized, mechanical, or a combination thereof, and whether played on a networked device, a cloud-based device, a software-driven device, a stand-alone application on a mobile device, a browser, or a dedicated gaming system such as a video slot machine, sensu lato, where a risk of monetary loss (or gain) is inherent in playing the game.

“Bet” (verb)—to risk something, usually a sum of money, on one or more alternative outcomes of a future event, such as an intermediate result or an end result of a game. Synonymous with “wager”.

“Bet” (noun)—the act or amount of risking something on one or more alternative outcomes of a future event, such an intermediate result or an end result of a game.

“Dice cube”—refers to a conventional six-sided cube having “pips” individually marking each face of the cube. The cube faces are traditionally marked 1 through 6 by the number of pips displayed on the face. “Dice” may also be used generically to indicate dice members having 8 or 12 faces, for example.

“Natural”—refers to the face of a dice cube that is face-up after the dice cube is rolled. Naturals may be combined in some aspects of the game so as to eliminate numbered positions higher than a six, the highest natural on any one dice.

General connection terms including, but not limited to “connected”, “attached”, “conjoined”, “secured”, and “affixed” are not meant to be limiting, such that structures so “associated” may have more than one way of being associated. In computerized systems or networks, devices may be termed to be “digitally connected” such that there is a wired or a wireless exchange of data between the two devices. Data connotes a digital state of one or a plurality of logic elements, such as transistors.

Relative terms should be construed as such. For example, the term “front” is meant to be relative to the term “back,” the term “upper” is meant to be relative to the term “lower,” the term “vertical” is meant to be relative to the term “horizontal,” the term “top” is meant to be relative to the term “bottom,” and the term “inside” is meant to be relative to the term “outside,” and so forth. Unless specifically stated otherwise, the terms “first,” “second,” “third,” and “fourth” are meant solely for purposes of designation and not for order or for limitation. Reference to “one embodiment,” “an embodiment,” or an “aspect,” means that a particular feature, structure, step, combination or characteristic described in connection with the embodiment or aspect is included in at least one realization of the present invention. Thus, the appearances of the phrases “in one embodiment” or “in an embodiment” in various places throughout this specification are not necessarily all referring to the same embodiment and may apply to multiple embodiments. Furthermore, particular features, structures, or characteristics of the invention may be combined in any suitable manner in one or more embodiments.

It should be noted that the terms “may,” “can,” and “might” are used to indicate alternatives and optional features and only should be construed as a limitation if specifically included in the claims. The various components, features, steps, or embodiments thereof are all “preferred”—whether or not specifically indicated as so. Claims not including a specific limitation should not be construed to include that limitation. The term “a” or “an” as used in the claims does not exclude a plurality.

“Conventional” refers to a term or method designating that which is known and commonly understood in the technology to which this invention relates.

A “method” as disclosed herein refers to one or more steps or actions for achieving the described end. Unless a specific order of steps or actions is required for proper operation of the embodiment, the order and/or use of specific steps and/or actions may be modified without departing from the scope of the present invention.

“Adapted to” includes and encompasses the meanings of “capable of” and additionally, “designed to”, as applies to those uses intended by the patent. In contrast, a claim drafted with the limitation “capable of” also encompasses unintended uses and misuses of a functional element beyond those uses indicated in the disclosure. Aspex Eyewear v Marchon Eyewear 672 F3d 1335, 1349 (Fed Circ 2012). “Configured to”, as used here, is taken to indicate is able to, is designed to, and is intended to function in support of the inventive structures, and is thus more stringent than “enabled to”.

Unless the context requires otherwise, throughout the specification and claims that follow, the term “comprise” and variations thereof, such as, “comprises” and “comprising” are to be construed in an open, inclusive sense—as in “including, but not limited to.”

The appended claims are not to be interpreted as including means-plus-function limitations, unless a given claim explicitly evokes the means-plus-function clause of 35 USC §112 para (f) by using the phrase “means for” followed by a verb in gerund form.

### DETAILED DESCRIPTION

### Overview

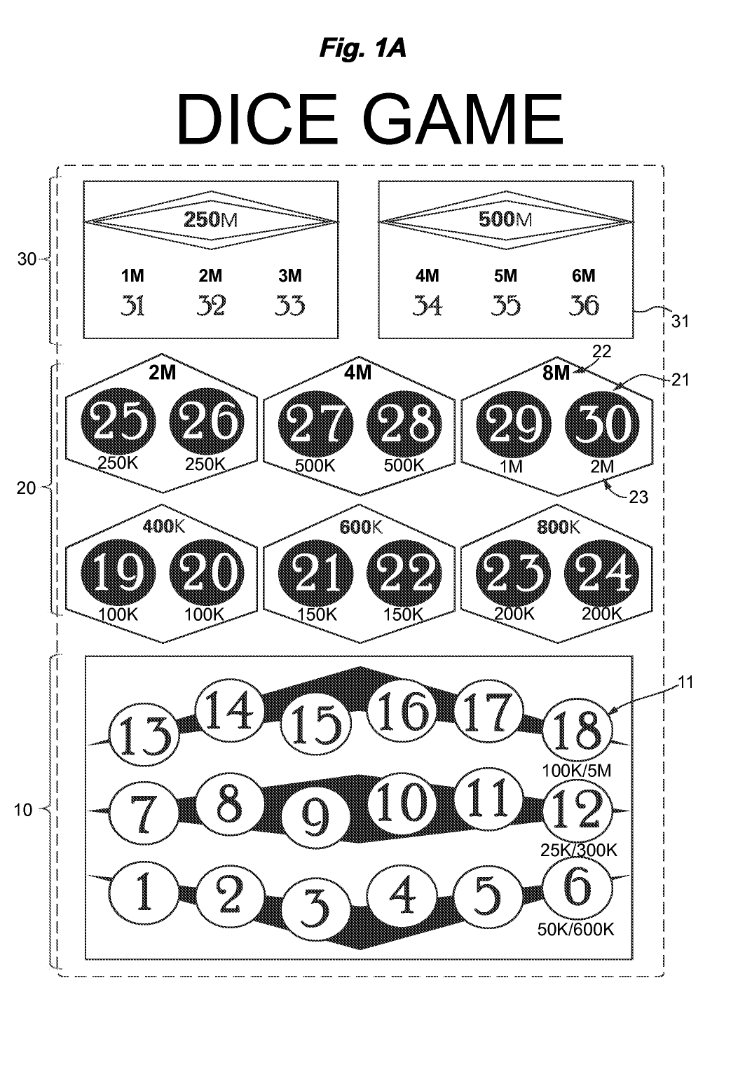

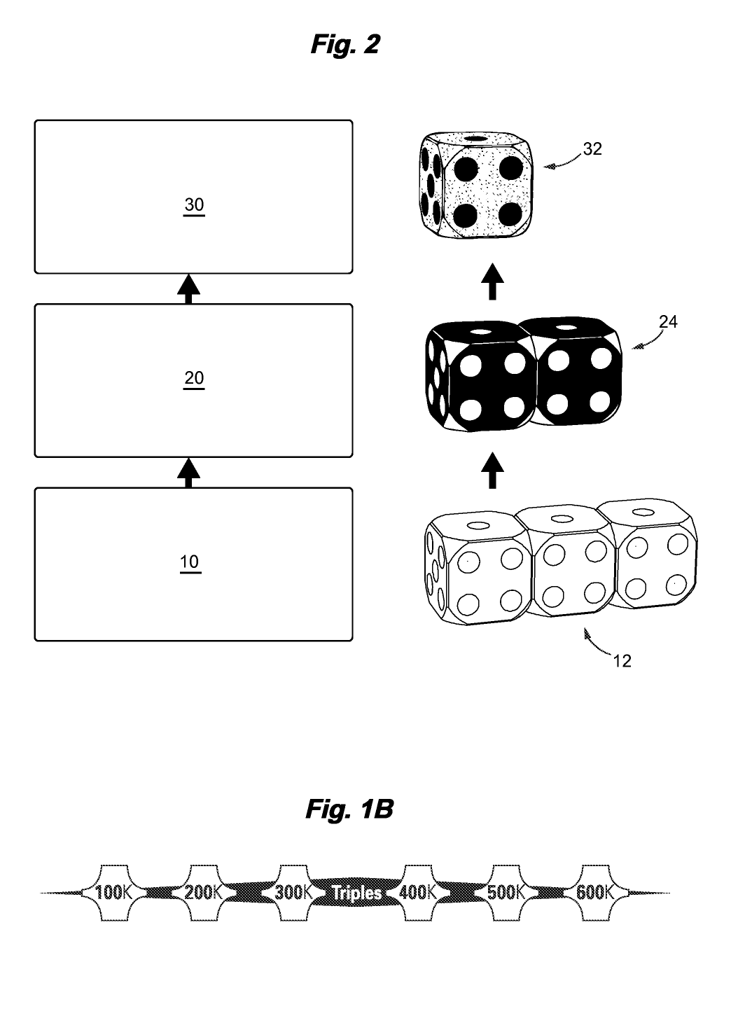

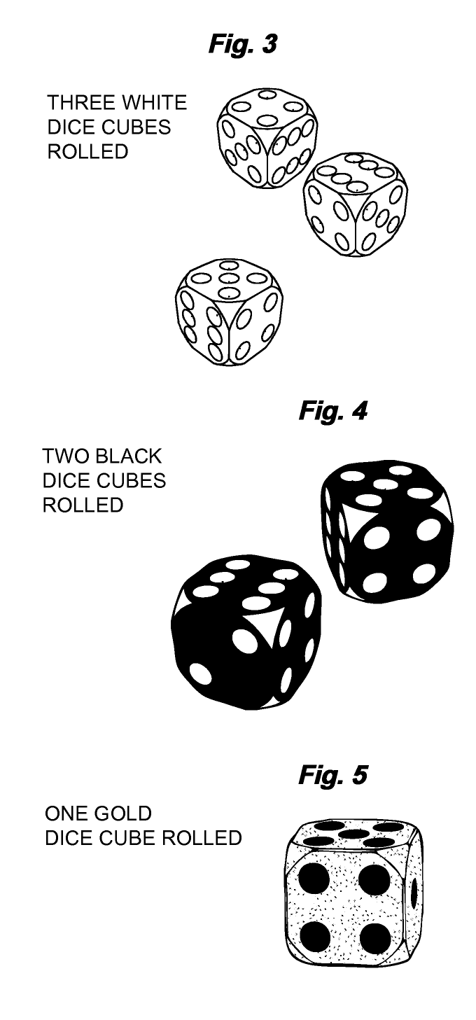

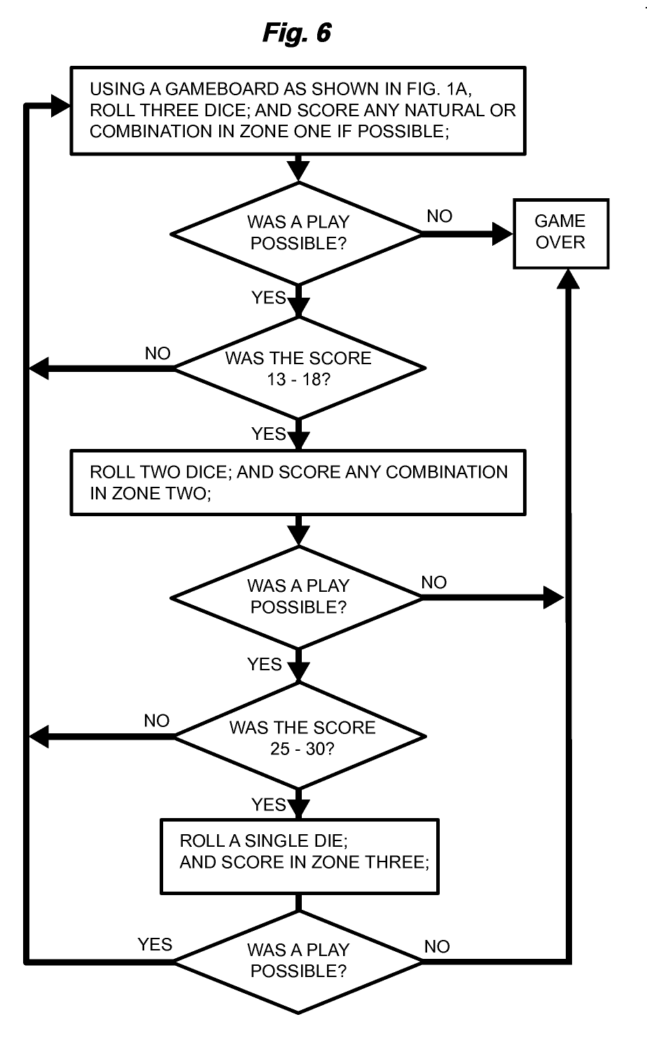

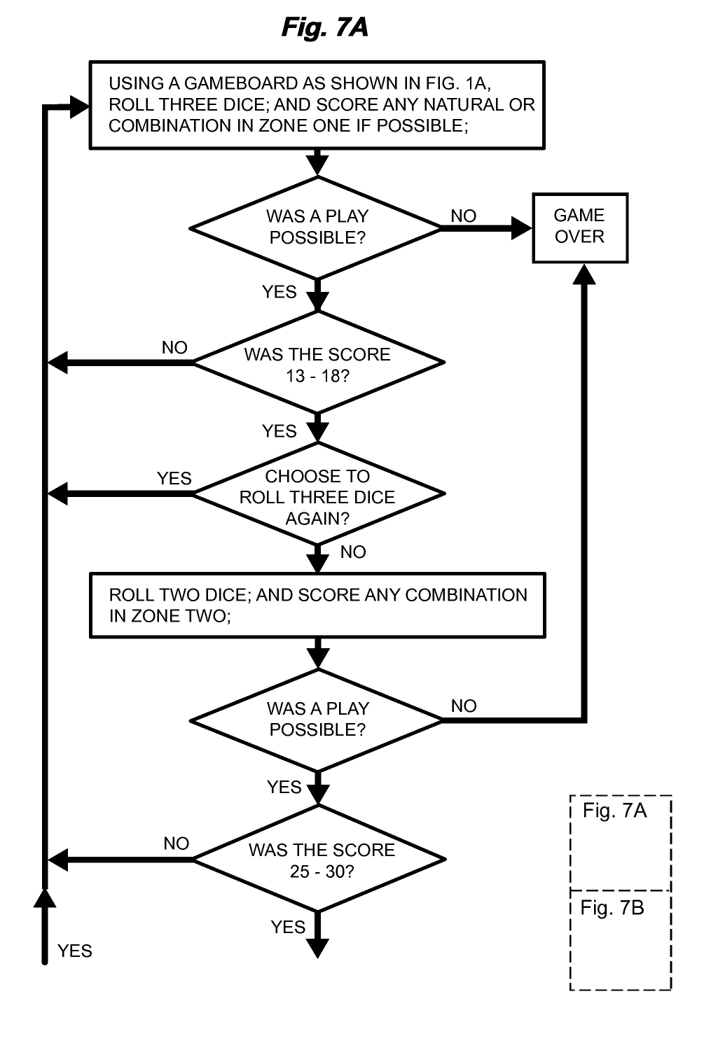

In a first exemplary illustration of a dice gaming system of the invention, virtual dice are thrown on a virtual gaming board of FIG. 1A, shown here as displayed on a figurative LED screen (dashed box). The gaming board (“gameboard”) is provided with selectable positions (numbers 1 through 36) configured for a numbers elimination game played with virtual dice. In a preferred embodiment, the gameboard is expanded into three (3) sections or “zones” (10, 20, 30). The game is played by rolling six virtual dice cubes. Also provided are automated virtual markers to cover or delete the thirty-six numbered “selectable positions” on the gameboard when “an elimination” is scored. This view is representative of an “initial game state” presented by the gaming system on a player interface. The player interface is also configured to initiate dice rolls and to select individual board positions for elimination under control of the player. In preferred gaming systems, the player interface may be integrated in full or in part into the gameboard using touch screen technology. The player interface may also a scoring utility to speed and facilitate playing. Devices for accepting bets and dispensing winnings may also be provided.

Referring again to FIG. 1A, the lower panel (10), ZONE ONE, contains numbered positions 1 to 18 (11); each position is encased in a white circular field and the fields are organized into three rows, where each row is defined by a dark band. The center panel (20) is ZONE TWO and contains numbered positions 19 through 30. ZONE TWO is organized into two rows, the lower row containing the numbers 19-24, the upper row containing numbers 25-30 (21). ZONE THREE (30) contains numbered positions 31 through 36 (31). The gameboard is a virtual gameboard on an electronic display.

Each numbered position and/or row is also associated with a valuation, shown here as a smaller indicium having a number followed by a “K” for “thousand” or an “M” for “million”. In a virtual game, the numbers may be displayed over the numbered positions in a phantom typeface, for example. In ZONE TWO, players eliminating any pair of numbers in the polygons are awarded an extra score (22) in addition to the smaller amount (23) shown below the black circle. In ZONE THREE, players eliminating either the right three numbers or the left three numbers in one game are rewarded with 250M or 500M added to their score. Scores are also increased by eliminating all the members of any row. Other variations in scoring may be devised as favored by the game designer. A running tally is also displayed. Scoring aids also include the display shown in FIG. 1B, which is used for scoring rolls of three dice that are “triples”, where each dice comes to rest face up with the same number.

A view of the six dice used in the game is shown in FIG. 2. Three white dice (12) are rolled to cover (eliminate) numbers in ZONE ONE (10). A pair (24) of black dice are rolled to eliminate numbers in ZONE TWO (20). One gold die (32) with black pips is rolled to cover numbered positions in ZONE THREE (30). Where dice are rolled digitally, the dice throw may be represented by an animation. In another version, the dice “throw” is stylized or simplified roll throw is generally determined by a random number generator (RNG). The player has the option of playing the natural dice face values that are rolled or combining the face numbers as part of a game strategy to score into the higher zones of the game.

### Buy In

The online version of the game is a no-limit high stakes game. The minimum buy in is 1M chips, for example. A player may choose to increase the ante, but only in multiples of 1M. Only one bet is made per game. The gameplay may result in a gain in the player's reserve, a partial loss, but cannot result in a total loss of all chips on a first game. These and other betting rules are administered by the gaming system.

### Play

The game starts by rolling three virtual white dice. Illustrations of a three dice roll and a two dice roll are shown in FIGS. 3 and 4. A roll of a gold dice cube is shown in FIG. 5. Dice can be added together or played as naturals. For example, a 2-4-5 roll offers five options:

Cover/Eliminate: 2-4-5 6 [2+4] and 5 9 [4+5] and 2 7 [2+5] and 4 11 [2+4+5]

Push: If two dice added together equal the third die, say a 1-4-5 roll (1+4=5 and 5), a push may be called. A push offers the player the option to play the roll, or automatically re-roll the white dice. There is no limit to how many times during a game a player can call a push.

Seven or eleven: If on the opening roll, a 7 or 11 (example 1-1-5 or 2-3-6) comes up, cover (eliminate) the numbers rolled (#7 or #11) and collect 50 $ bonus chips as a onetime pay out.

Triples: If on an opening roll triples come up, the player wins double $ chips. For example, a roll of 4-4-4 (400K) would pay 800K $ chips. The 400K would be covered, but numbers on the triples line (FIG. 1B) are not eliminated, and it can be scored again (4-4-4) later in the game. Important: If a player rolls triples but is unable to cover a number(s) in the lower section because the naturals and combinations are already eliminated, the player only needs to cover the triples number (FIG. 1B, in this case 400K on the triples line) to continue the game. Thus triples serve to provide a free roll and keep play going. Game rules may also include additional ways to score, including, but not limited to other bonus scores and double point scores.

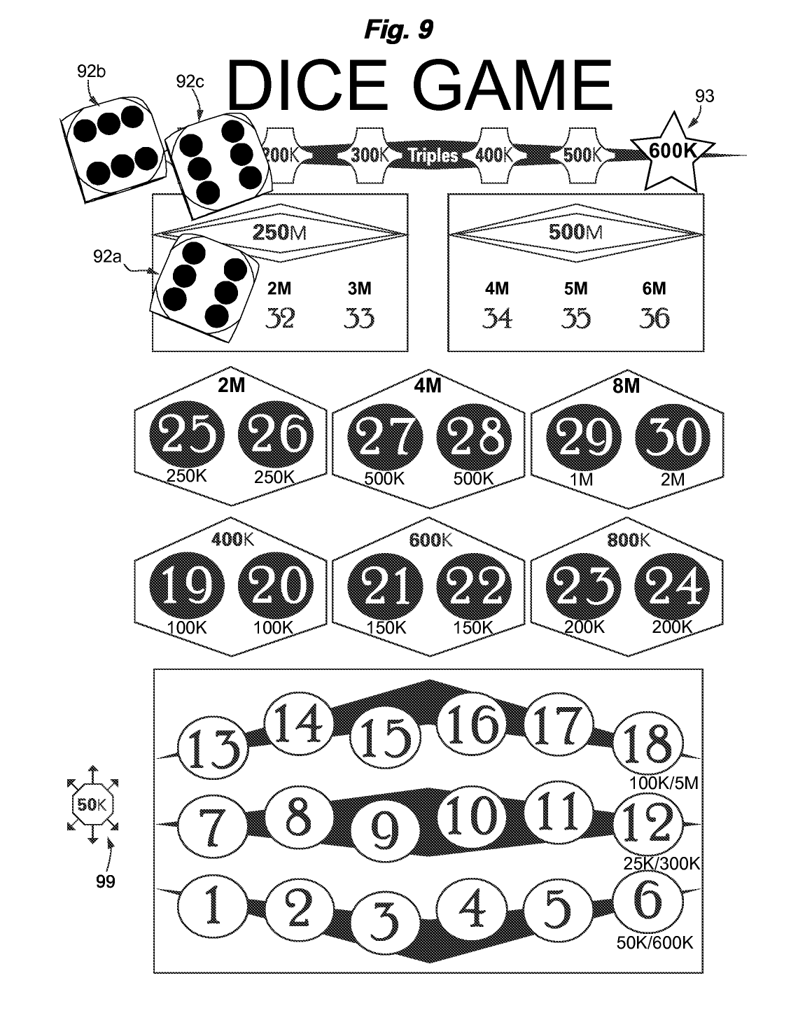

Up & Down: The potential chip ($) count is shown on the right side of the lower section of the screen view of FIG. 9: for example, the first row shows 50K/600K. For every number covered (eliminated) between #1 and #6, the player receives 50K $ chips. If all six numbers in that row are covered (eliminated) 600K $ chips are paid out as a bonus.

Advancing to Higher Zones: If a white dice roll totals 13 to 18 points, the player is eligible to roll the two black dice with the hope of covering a number in the middle section (ZONE TWO). For example a roll of (5-6-6) allows the player to eliminate #17 on the top line of ZONE ONE. The player is then eligible to try an increase the game score by rolling the two black dice. For example, playing to advance, the pair of black dice come-up 5-6 (=11). Great roll! The player now adds the “#17” in the lower section (the highest score rolled with the three white dice) with the “11” roll (rolled with the pair of black dice) and covers the “#28” for 500K $ chips. Because the player landed on a number between 25 and 30, the player may continue trying to advance by rolling the solitary gold die (32). A player who rolls a “4” with the top dice cube advances from the highest covered position numbered “#28” by counting four additional positions and covering the “#32” position for an additional 2M $ chips, a roll that increases the players score exponentially (cover/eliminated: #18 for 100K-#28 for 500K-#32 for 2M, equals total 2.6M $ chips). In this version of the game, players get one chance only to roll the gold dice and score in ZONE THREE.

If successful, the player continues play by rolling the three white dice and scoring in ZONE ONE until trapped (end of game).

Important: If the player decides to cover (eliminate) a number between 13 and 18, there's no turning back, which means that for any roll of the two black die that does not allow the player to eliminate a number in ZONE TWO—game over. For example, if the player rolls (3-5-6) and covers the #14, the next roll must be higher than 4 or the game is over with a final score. If the player rolls the two black die and cannot advance into the middle section, either because [1] the black die combination was not high enough (say 1-3=4 which ends at #18) or the number in ZONE TWO is already covered (eliminated); then game over. The greatest rewards go to high rollers. Examples of high rolls are shown in FIGS. 3, 4 and 5.

Game Over! The game ends when [a] the player is unable to place all three of a roll of the white dice in the lower section, ZONE ONE; [b] when the player is unable to place all two of a roll of the black dice in the middle section, ZONE TWO; or [c] when the player is unable to place a roll of the gold dice cube in ZONE THREE at the top of the gameboard. These are also termed game ending “trap conditions” or “terminal conditions” and result in display of a final game state where bets are resolved and the game may be reset to its initial state so that play can start again. Management of updating intermediate game state and final game state mechanics is provided by the gaming system.

An exemplary game flow chart is generally as shown in FIG. 6. At the beginning of each game, any game scores and positions in RAM are generally reset to the initial game state. Player winnings and cash or bonus positions may be carried forward from one game to the next.

As defined in programming, a display controller is used to display a gameboard such as the one illustrated in FIG. 1A. This board defines three zones, ZONE ONE (10), ZONE TWO (20), and ZONE THREE (30), each zone containing multiple numbered positions (11, 21, 31) as shown. This condition is termed an “initial game state”, and ends when the player initiates the first dice throw.

### Three White Dice

The player rolls three white dice and selects one or more scores from the following set S1 of seven possible combinations:

S=[x, y, z, (x+y), (x+z), (y+z), (x+y+z)]

where x, y, and z are the natural scores face up on the dice cubes.

Each face of the dice must be used in one and only one play. No dice face may not be used; and the player must play all dice from each roll, either as a natural or as a combination.

For each score selected, the gaming system deletes the corresponding numbered positions between #1 and #18 from ZONE ONE.

The player repeats rolling the three white dice while the gaming system iterates the program loop until one of the following logic conditions occurs:
[a] no further numbered positions can be deleted in rows 1 and 2 of ZONE ONE (i.e., numbers 1-12); or,
[b] at least one of the face up dice faces cannot be played (because no corresponding numbered position on the game board remains to be eliminated); or,
[c] the player plays a combination between 13 to 18, advancing play to the top row of ZONE ONE.

If all play options have been exhausted and a dice face has not been played—game over. End game conditions may at any time during play in which a trap condition is met; the bet is resolved according to the score when that play is completed and no further dice may be rolled. Any winnings are awarded and the game is reset.

However, if a dice combination between 13 and 18 is played, the gaming system eliminates the numbered position corresponding to the combination, and, for the next roll, the player will roll the two black dice.

### Two Black Dice

From the roll of the two black dice, the player must play one or more naturals or combinations from the following possible set S2 of three possible plays:

S2=S1_{HI}+[x, y, (x+y)],

where S1_{HI} is the highest combination played in the third row of ZONE ONE in the preceding step, and x and y are dice naturals.

If all of the values [S1_{HI}+x; S1_{HI}+y, S1_{HI}+(x+y)] are less than 19—game over. If the total(s) S2 is/are greater than 18, then delete the corresponding numbered position(s) from ZONE TWO. If any of the dice faces cannot be played: game over.

Note: The black dice may be rolled several times during a game, but only once per turn. If the two black die total a score that eliminates a number in the top row of ZONE TWO (25-30), then the gold die may be rolled. However, if the black dice in combination eliminate only a number between 19 and 24, then the player continues by rolling the three white dice and scoring in ZONE ONE until trapped.

### Single Gold Die

Roll the gold die. Set S3 is the sum of any natural (x) rolled with the gold dice cube plus the highest combination S2_{HI} played on the top row of ZONE TWO.

Note: The same rules apply to the single gold die as with the two black dice. If, with a single roll, the player is successful in scoring in ZONE THREE (#31-#36), then that highest numbered position is eliminated. On the next roll, the player rolls the three white dice and continues scoring in ZONE ONE. Players may again advance to higher zones, but at each round in ZONE TWO or ZONE THREE, only a single dice roll is allowed.

When a player is in a trap condition, all play is terminated and the final total of all points scored is displayed. The value of each numbered position that was eliminated is assigned by the game designer and is recorded with the program instructions for playing the game. The ante is subtracted from the winnings to determine the net due the player. If the player fails to recover the ante, the player scores the game a loss. The player may then ante in to start a new game. The gaming system will tally the winnings and when the player exits the game, may be configured to dispense any cash or winnings in the form of a voucher, game ticket, coins, chips, and so forth, which may have cash value if desired.

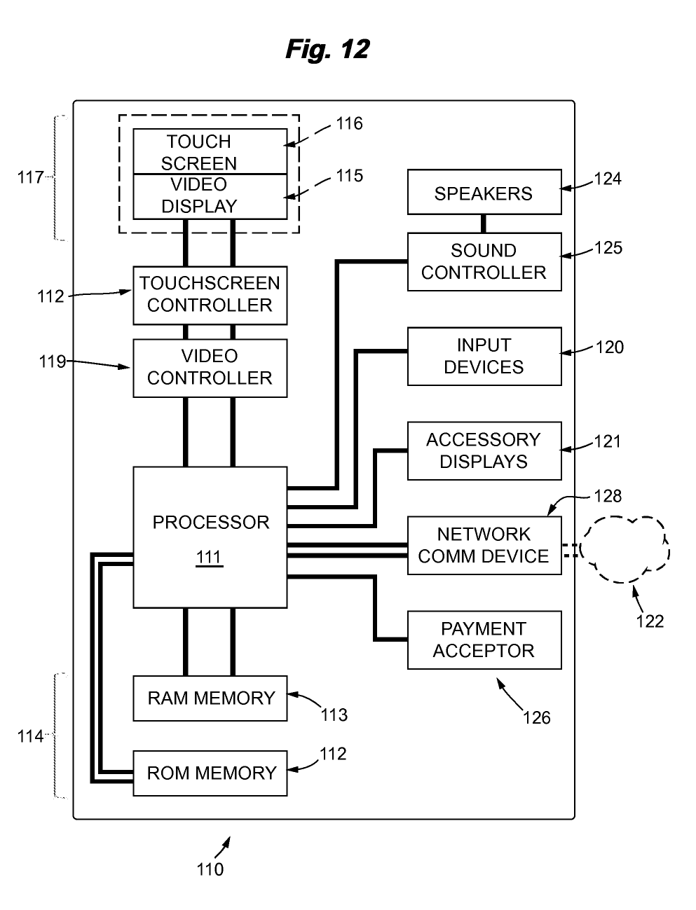

A touch-sensitive screen integrated into a video display provides player control, and may be used in conjunction with a player game management console (117, 120, 126, FIG. 12) having “hard” and/or “soft” player control features. Alternatively, special keypads may be used to control a cursor or to permit rapid navigation of the gameboard, such as with a joystick. In preferred systems, the player will be shown the results of the dice roll and will be offered a list of all the possible plays that are allowed based on the dice roll and asked to select a play by touching one play from the list. A back button will allow the user to correct errors.

Thus in a preferred embodiment, the gaming systems are designed for operating a virtual dice elimination game of chance, the system having a non-volatile memory device, wherein the non-volatile memory device is configured to store digitally-encoded instructions to perform a game method; b) a processor (or processors) digitally coupled to the non-volatile memory device, wherein the processor is configured to execute the instructions; c) and a player interface operatively coupled to the processor, wherein the player interface is configured to receive inputs from a player and to display a game state according to the instructions. By way of example, the preferred game method involves steps for (i) starting a game by displaying an initial game state on the player interface, the initial game state comprising a virtual gameboard having three zones, a first zone having selectable positions designated by numbers 1 through X, a second zone having selectable positions designated by numbers X+1 through Y, and a third zone having selectable positions designated by numbers Y+1 through Z, wherein all selectable positions are open for play; (ii) executing a dice throw upon receiving a signal from a player, wherein one or more virtual dice are thrown, and displaying a set of randomized dice face values having one face value for each dice thrown; (iii) for elimination, receiving a selection or selections of any selectable position or positions having a number corresponding to either one dice face value or an addition of dice face values from the set, clearing any dice face values that result in an elimination until no dice face values are left in the set, and displaying an updated game state differentiating selectable positions on the gameboard that are either open for play or closed by an elimination; (iv) iterating steps (i), (ii) and (iii) until further eliminations of selectable positions open for play is not possible based on the set of dice face values thrown; and, (v) displaying a final game state to show any dice face values not cleared, and a game score based on all the eliminations from steps (iii) and (iv). The gaming systems may also include devices configured to receive a bet or bets when starting a game and to resolve any bets based on the score. As currently preferred, X=18, Y=30 and Z=36.

The programmable instructions may include steps for (a) beginning gameplay by rolling a three dice cubes and eliminating at least one numbered position in the first zone; (b) conditioning gameplay such that if a numbered position is eliminated, it is not available for further selection; (c) ending gameplay if any dice roll results in a trap condition in which at least one the dice face values of the set cannot be used to select an elimination, further wherein each dice face value of a dice roll is used once and only once; (d) continuing game play by rolling three dice cubes and eliminating any dice cube values in the first zone until the sum of the three face values thrown is greater than X, then rolling only two dice cubes and selecting for elimination at least one numbered position in the second zone corresponding to the addition of the highest elimination value in the first zone from preceding play and a face value of one or both of the two dice cubes as rolled; (e) conditioning gameplay such that if the summation from step (d) is greater than Y, then rolling only one dice cube and selecting for elimination one numbered position in the third zone corresponding to the addition of the highest elimination value in the second zone from preceding play to the face value of the one dice cube as rolled; (f) conditioning gameplay by continuing as in step (ii) if any roll of two dice does not result in a roll of a single dice, or if any roll of a single dice results in an elimination in zone three; (g) after any roll of three dice which results in a triple, triggering an automatic extra roll of three dice; (h) conditioned on encountering a game state such that no further elimination of selectable positions open for play is possible, summing all the numbered positions eliminated during play and displaying a score derived therefrom; or, (i) conditioned on encountering a game state such that no further elimination of selectable positions open for play is possible, determining the highest number eliminated in each zone and displaying a score. A value is assigned to each numbered position prior to the start of the game, and a score for the game is a sum of the values for each numbered position eliminated.

Having other versions of the game may be desirable. For example, six dice may be played initially such that a player can attempt to fill ZONE ONE before advancing to ZONE TWO. Or players may be allowed to drop one dice selection from one or more rolls so as to increase the overall play time before a “trap condition” that stops play is encountered. In another variant, an icosahedral dice is used having 1 through 12 numbered faces, and the game zones are adjusted to allow for faster, higher scoring where additive rolls allow a player to advance quickly to stratospheric wins. Thus the particular rules of the game disclosed here are not a limit on the invention, and may be modified without departing from the spirit and scope of the invention where interest, excitement, and betting on the game can be increased.

The particulars of any gameboard and game rules are subject to change according to the responses and analytics received from players. Game systems having EEPROM memory chips may be readily modified by swapping out the memory chips with revised executable instructions.

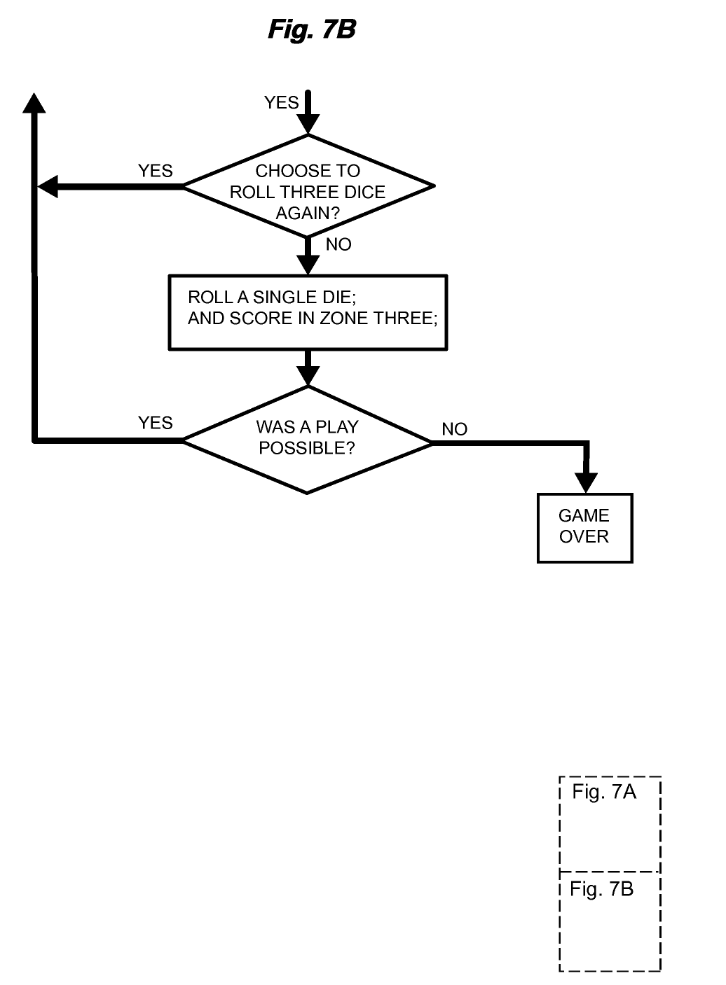

A more complex game flow chart is shown in FIGS. 7A-7B. In this flow chart, players are offered additional play choices, increasing the element of strategy. Unlike the preceding game, the player need not roll the black dice when a score of 13-18 is played. Players who wish to continue with the three white dice may do so. Players who choose to roll the black dice may do so only once per turn. If the two black die total a score that eliminates a numbered position in the top row of ZONE TWO (#25-#30), then the gold die may be rolled. If the black dice in combination eliminate only a number between 19 and 24, then the player continues by rolling the three white dice and scoring in ZONE ONE. If the white dice or the black dice are rolled and cannot be played, then the game is over.

The same rules apply to the single gold die as with the two black dice. The player need not roll the gold dice when a score of 25-30 is played. Players who wish to continue with the three white dice may do so. Players who choose to roll the gold die may do so only once per turn. If, with a single roll the player is successful in scoring in ZONE THREE (31-36), that highest number is eliminated. On the next roll, the player rolls the three white dice and continues scoring in ZONE ONE. Players may again advance to higher zones, but at each round in ZONE TWO or ZONE THREE, only a single dice roll is allowed. If the white dice, the black dice, or the gold die are rolled and cannot be played, then the game is over.

This more advanced game may be played as an option accompanying the game of FIG. 6. For example, two games may be offered so that beginning players may choose the first game, and advanced players may progress to the game of FIGS. 7A-7B. The advanced game may be tied to higher stakes so as to add excitement. Players who try the advanced game will surprisingly discover that it bears no resemblance to legacy games, allowing players multiple attempts to top their highest score, but with each return to the white dice, having a greater chance of scoring out by encountering a trap condition.

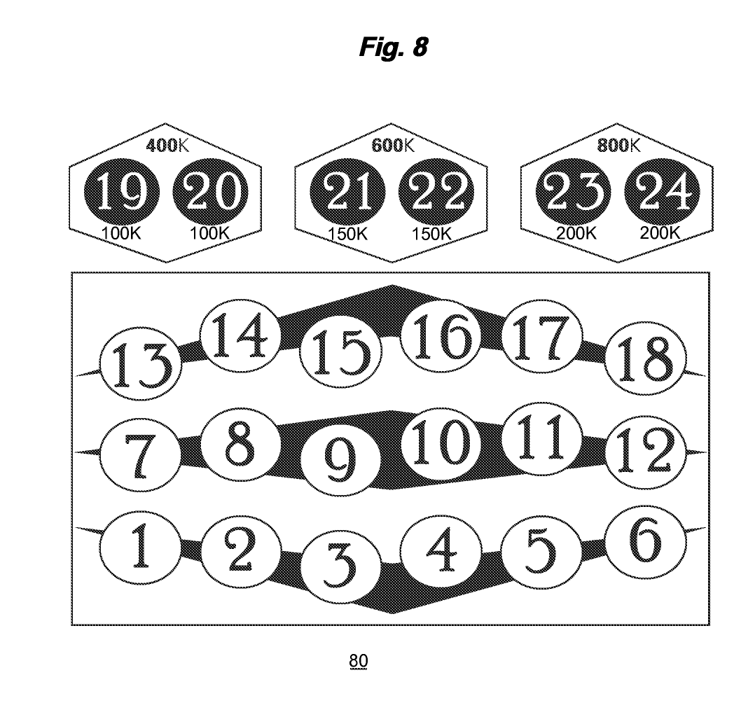

FIG. 8 shows a simplified gameboard 80 having twenty-four numbered positions, eighteen numbered positions in a ZONE ONE, and six numbered positions in a ZONE TWO. The game is played with three dice operable by the program of a gaming system. However, in testing, players starting with three dice readily hit a ceiling and rapidly lost interest in the game.

FIG. 9 is a view of an improved gameboard 90 having three zones with thirty-six numbered positions, a triples line, and bonus scoring utility. High dice rolls advance the player to the upper scoring levels. The gameboard will have displays that track the user's play and update the status of each numbered position. Typically the game is played with three dice in the first zone and two dice in the second zone, and progresses rapidly to elimination of a high scoring numbered position or an “end of game” (trapped) condition. Players may score extra points by rolling triples, rolling 7 or 11 on the opening roll, or for rolling five sixes, and so forth; management of which is automated by the processor. Management of the overall scoring is also integrated into the computer program so that the player is free to enjoy the game. Each position that is eliminated is associated with a defined number of points so that the outcome of the game can be valued according to a player's total score. The apparatus will generally include program instructions for receiving one or more bets on an outcome of the game play, and for terminated play by resolving any bets, or providing an alternative means for paying the game operator, such as by subscription, by a pay-to-play system as through an internet gaming site, or by incorporating advertising and player recruitment windows. In one strategy, players are rewarded for recruiting “friends”, ensuring the game operator a free supply of new sales leads. A leaderboard or other social gaming provisions may also be incorporated to encourage players to challenge their friends to play.

Extra points may be given for scoring on diagonals, columns or rows 91. As a supplement to the rules, for every sequence of three numbers lined up and down or diagonally, an additional 50K $ chips are paid out. For example, cover 2-8-14 for 50K $ chips and 3-8-13 for another 50K $ chips. Scores are tabulated automatically. Other supplemental rules may be included if desired and are administered by the gaming system. While not shown, the player may view the cumulative score in real time in a tally window or via a speaker.

In FIG. 9, a virtual dice throw is shown. The dice bounce and tumble across the display surface in a lifelike three-dimensional rendering or animation, before stopping at their final resting places, each with an exposed dice face value on top (92a, 92b, 92c). Here the player's first throw of a new game results in three sixes, a triple six as shown by the star (93) in the triples scoring line. Players who consistently roll high dice numbers do very well in the game, which is fast moving and quickly builds momentum. The game is designed for solo play, although match play with competition among players is also possible.

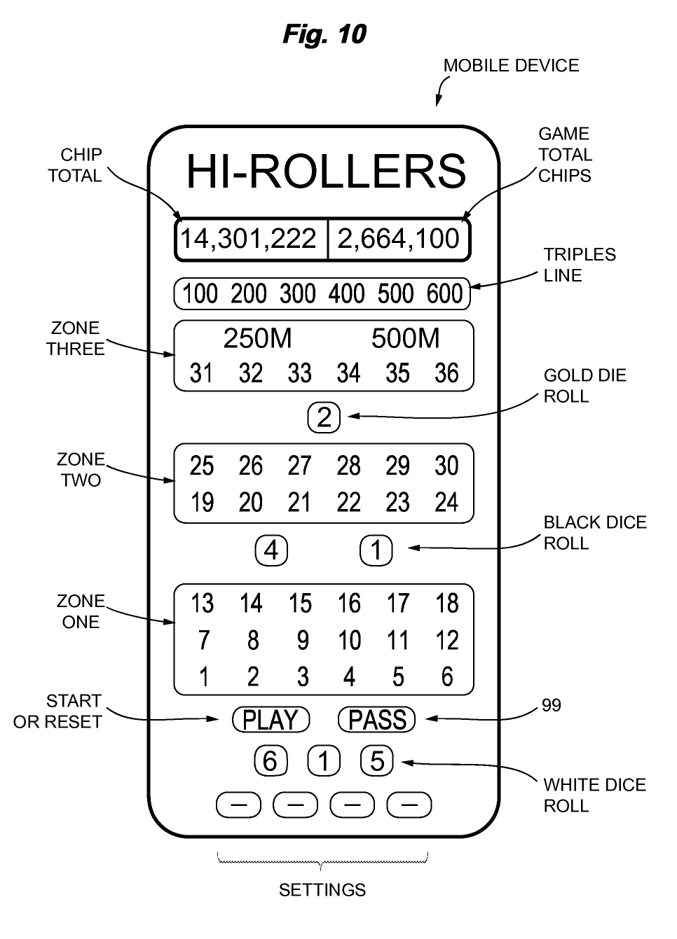

FIG. 10 is a view of a simplified player interface of an exemplary gaming system of the invention as implemented for solo play on a mobile device, here a smart phone configured with a game “App”. Shown is a device operative to play a three-zone game essentially as described in FIG. 6. Soft buttons are updated as play advances and the game may include a demo mode or rules mode to facilitate learning the rules. For example, as soon as a dice combination is distributed for scoring by the player, the program automatically initiates a new dice roll and shows the available dice. Using this feature, players are not confused about whether to roll two, three, or just one dice cube. When a game is over and the player has played their last dice roll, the PASS-ROLL button 99 disappears and is replaced by a slightly larger button that reads NEW GAME. By tapping the new button, game RAM is cleared and a new roll of the three white dice is presented to the player. Scoring is stored in memory separately, and may be saved in a temporary buffer so that a player may continue to tally wins and losses until the new game button is pressed and held to clear memory completely.

Advantageously, the complexities of the game are made more user friendly when performed on a computerized gaming device such as a mobile phone device or a casino gaming machine. Automating the point totals allows the user to concentrate on strategies for distributing the dice scores onto the gameboard after each roll. In this way the dynamics of a virtual dice throw is transformed into a score that is in turn linked to an award; the award motivating the player to start a rematch . . . or to build a social network around the game. The gaming machine or system has a transformative effect on the digital environment and is manifested in wins or losses of material value and/or in development of real relationships through social networking, for example.

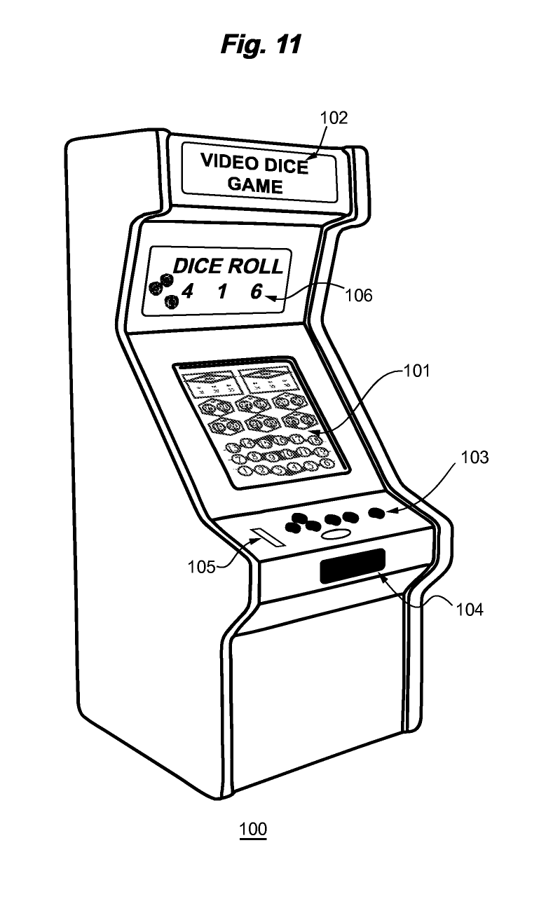

FIG. 11 is an exemplary video gaming machine of the invention having programming for playing an elimination dice game, and may be a standalone computing machine or may be operated as part of a network of computing machines. The machine features a frontal user interface with video screen (101) displaying a gameboard, a logo display screen introducing the new game (102), user analog controls (103), a coin tray or bin (104) for dispensing winnings, and a coin or card acceptor (105) that may also be used with casino chips or tokens. An accessory display panel (106) is used to display each dice roll result, and may include an animation of rolling dice. At least one of the controls, either an analog hard button or a soft selection control on a touch screen user interface may be used to select from the available themes for the game, where themes include a choice of colors, graphical and audio effects, and also special accessibility features such as larger fonts. Features 101 and 103 may comprise a player management console having controls and displays for playing the game. Feature 103 may include one or more hard buttons or joysticks on the console; feature 101 may include soft control surfaces projected onto the display screen by the software that are operated by a player's touch (or gesture).

In a preferred embodiment, outcome of the dice throw is not a mere pick of a random number generator. Dice are vectored according to their relative position at the start of a throw, and the physics of elastic collisions and momentum are used to plot a final resting position for each dice cube on a virtual surface. The dice operator will ensure that the kinematic equations used to plot virtual dice trajectories result in random outcomes for each dice roll. This programming approach is more exciting to the player than an approach in which a random number generates an outcome and then feeds the predetermined end result to an animation routine that back calculates a simulation of a dice throw back into a cup before showing the dice throw on the view screen. As compared to conventional technology, such as described in U.S. Pat. No. 4,506,890 to Murry and the cited references therein, a realistic simulacrum of a dice throw will fascinate users, creating a game they cannot put down. Co-owned patent application titled, “Gaming system, Apparatus and Methods of Electronic Gaming with Virtual Dice” contains other innovative dice arts and is incorporated in full for all it teaches and for all it incorporates by reference.

The gaming system may further comprise a credit meter balance displaying the player's reserve. The credit meter balance indicates the amount of electronic credits currently available to a player for wagering and/or providing payment for options available via the gaming system user interface. The electronic credits may be used by a player, for example, as bets for playing games on the gaming device and/or for providing payment for a play session and/or one or more bonus rounds. The electronic credits may also be “cashed out” as coins, bills, tokens, a cashless gaming receipt, and/or credits to another financial account associated with the player. Payment to the player may be rendered, for example, by dispensing coins into the coin tray or outputting a cashless gaming receipt from the ticket-in/ticket-out device, or by crediting a credit card or a room key. Such payment may be rendered based on, for example, a player's indication that the player would like to cash out his credit meter balance and/or a payout obtained by a player as a result of playing a game on the gaming system. Note that, where appropriate, the gaming system may include different and/or additional components besides those discussed above and will be configured according to the statutes of the jurisdiction where the game is played.

FIG. 12 is a schematic view of a computerized gaming system or platform (110) to be provided to a game operator, such that the gaming system includes features (including programming instructions) configured for operating one or more of the games described here. The components shown may encompass but are not limited by the components useful in enabling the games and may omit conventionally known components.

The computing machine or platform 110 for gaming includes a central processing unit (111, generically termed a “processor”), which is connected to a memory utility 114. Shown here are read-only memory elements (112, ROM) and random access memory elements (113, RAM) such as are known to facilitate execution of a program by a processor. ROM elements may contain programming instructions in generally non-volatile storage form, and RAM elements typically store data temporarily, data that is reset such as at the start of a game or a game series, or in the course of iterating a program loop. Soft RAM is used for recording bets made during a game, for example. RAM typically has memory locations associated with game status, accessory display status, and soft button status on the user interface. These memory locations store information about the indicia at play, user preferences such as themes selected by the player, the bets placed, the player's winnings, the speed of the game, data for automatic play, and so forth.

In the depicted embodiment, the gaming system (110) includes memory for storing software (program instructions) for running games on the processor 111. Program instructions may be stored on a hard disk (not shown), but are more typically stored in ROM (112). Advantageously, the ROM memory may be an erasable programmable read only memory (EPROM), and yet more advantageously, the program instructions may be updated from an external digital connection 128 under control of the game operator.

Peripheral devices associated with the processor may include a video controller (119) and video display (115). In some embodiments, the video controller is embedded in the processor, but is a functional component identifiable as providing control of the contents of the video display (115), which may be an LED image, an LCD image, or a rasterized image of a CRT, for example. For gameplay having an integrated touch screen capability, the video display may be intimately associated with a touch screen (116) as represented here by combining the structures as a tactilographical display panel (117). The touch screen and video components may share data, and operate in digital communication with closely associated controllers (118, 119). It is not uncommon that video controllers contain added RAM memory as may be programmed to aid in executing video routines essentially as a co-processor when actuated by the processor.

In some gaming systems, an application specific integrated circuit (ASIC) may be used, limiting the requirement for software. These integrated circuit memory storage components are well known in the art so are not discussed further. The advantage to providing all game logic via a stored program on hard disk, or via a network communication device (128) from a cloud-based connection (122), is that a game and/or associated programmable thematics and style elements, may quickly and easily be updated, or a different game program be loaded to run on the computer without having to change any integrated circuit chips. In contrast, the ASIC approach offers speed of execution, reduced software and processor size, reduced bandwidth requirements, improved manufacturability and simplified troubleshooting capability; firmware finds application for gameboxes or casino gaming systems, for example.

Graphical rendering may be combined with random number generation in an ASIC device or a daemon on a co-processor, for example. The random number generation will operate cooperatively with the graphics software. In this way, virtual kinematics may be used to realize random outcomes of dice throws while providing highly realistic animations of dice body motion. Equations for 3D trajectories of dice that bounce and collide before settling onto a final resting place on a stage or gameboard may be solved by a processor, a co-processor, or an ASIC acting as a daemon or function call, termed here a “kinematics engine”, such that random outcomes are achieved so as to reduce the use of pseudo-RNG functions for the animations. More realistic animations of dice throws are an added benefit, and the player will appreciate that the dice throw cannot be known until the dice come to rest. Programming in support of virtual dice having trajectories derived from the kinematic equations for solid gamepieces in motion is an advance in the art that is realized in the games of the invention. A player may test the integrity of the game by tilting the virtual gameboard and noting that the roll of the dice extends over a bending trajectory because of the increased momentum, rolling farther when the gameboard is tilted down, and a shorter trajectory when the gameboard is tilted up, without any loss of the realism of the dice roll simulation. To achieve this effect, the gaming system may be provided with a micromachined gyroscope or multi-axis accelerometer. The typical 6-axis or 9-axis gyroscopes provided in modern cellphones may be hacked to power the kinematics engine with modified momentum estimates for the dice rolling on a game surface that may dynamically tilted. Dice that roll to a stop will be captured and scored but the user can continue to shake the device until satisfied that the dice are fully randomized. Some users will attempt to defeat the game by shaking the device to collect more high dice face values, but the system will flag this behavior and discount the game accordingly. Thus for match play or in games of chance linked to betting, player manipulations that seek to force dice into higher rolls would be disqualifying.

The processor may also be connected to other peripheral devices, the game management console having one or more accessory input devices (120) and accessory displays (121) and speakers (124) for audio effects. The speakers may be driven by an audio controller (125). Also linked to the processor is an optional payment acceptor (126) as known in the art, which may be a coin, token, or card acceptor configured to allow a player to place bets according to commands received by the processor from the player.

Network communications device (128) may be a network card for connecting the gaming system (110) to a central computer or server, such as over a cloud-based connection (122). The cloud may be used for accounting, bookkeeping, and/or security purposes, or for downloading new game software or game software upgrades and/or for controlling the operation of the game via a network if desired. The schematic enables cloud-based flash BIOS and remote reprogramming capability so as to refresh the games on a near-real time basis if needed. When game software remains on central computer in the cloud, games may be played over a local area network (LAN) operatively linked to the cloud, or over a remote network operatively linked to an internet-type domain generally resident on a server. Advantageously, by retaining some code on a remote server, proprietary aspects of the game or machine operation can be held as trade secrets.

Game requests may be transmitted via a network connection to a central computer and the game software is downloaded to resident memory to be used by the processor to run the game chosen by the player. A network connection may also be used to monitor game performance, machine performance, house winnings, and for remote troubleshooting, for example. Networking also is useful for storing user membership information, credit card information, security details such as pin numbers, and for collecting data on user preferences and history so as to present appropriate advertising or incentives, for example.

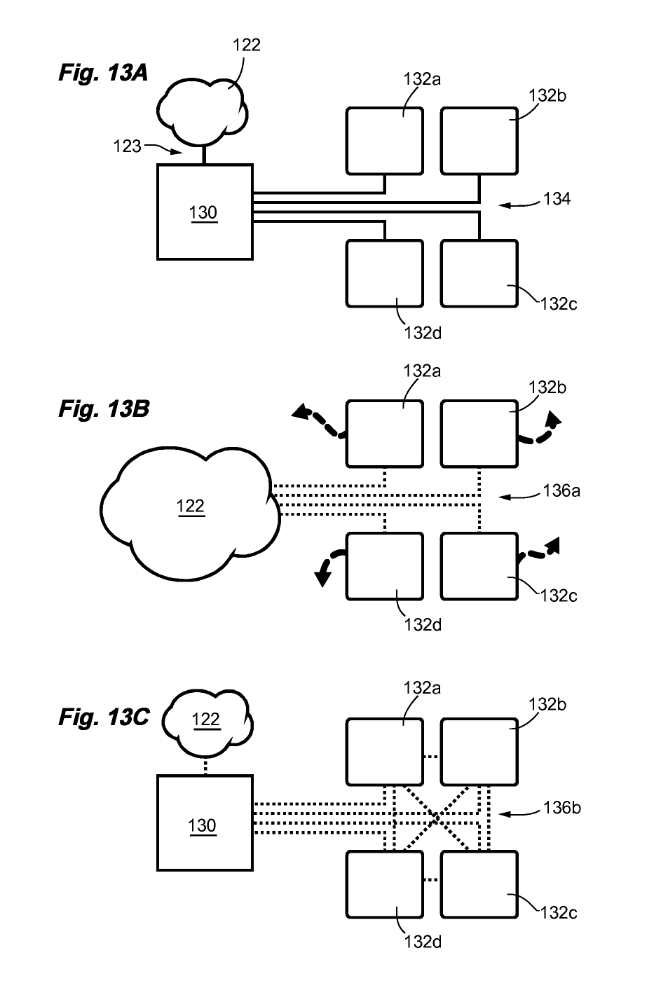

Wired and wireless communications platforms are known to those skilled in the art. Exemplary networks are depicted in FIGS. 13A, 13B and 13C. In each view, a cloud connection (122) is depicted figuratively. Although cloud-based computing machines or networks increasingly dominate many fields, the gaming systems of the invention may also be operated as stand-alone machines having no remote digital connectivity or having digital connectivity as a standby feature. Self-contained machines include a processor, a memory utility, user interface features, and programming sufficient to operate one or more games.

Digital network connectivity may by hard wired (134) or wireless (136a, 136b) as known in the art. In general, the figures depict hard wired data buses with solid lines and wireless serial data buses with dashed lines. Shown are a representative number of possible combinations. In FIG. 13A, a connection between a cloud-based computing facility and a local server is represented by a solid line or lines, such as via a fiber optic line (123). Digital connection protocols, whether wired or wireless, are generally bidirectional unless otherwise indicated. Wired connections (134) include for example Ethernet networks.

Wireless transceiver linkages useful in establishing networks broadly encompass cellular signals, WiFi, Bluetooth. Bluetooth Low Energy, Zigbee, and radio in general, including digital radio and analog radio. Cellular protocols include GSM, 3G, 4G, LTE, WiFi, or WiMax, for example. In some instances, peer-to-peer or star networks are created. Mesh networks having no centralized node may also be used. Mesh networks may be homogeneous and heterogeneous, for example employing gaming systems of the invention along with other kinds of nodes. Wireless networks, including ad hoc networks in general, are known to those skilled in the art and may be used in communication between devices and modules of the network. Frequency ranges are generally in the megahertz to gigahertz range, although lower frequencies may be used for longer distances. Each device of a network is typically assigned an address or identifier for communications, although the address may be static or dynamic. Encryption is optional, but is frequently used for communicating financial transactions and/or personal information. For wired network transmissions, serial transmission is generally contemplated, such as by UART-equipped devices, by ethernet, or by fiberoptic communications protocols.

As illustrated in FIG. 13C, the present invention may be configured to work as a component in a networked environment including a local server 130 (e.g., a gaming system server of a casino) that is in communication, via a communications network, with one or more gaming systems (132a, 132b, 132c, 132d) and a wireless mesh network connection (136b).

A variety of communications protocols may be integrated into the computing machines depicted in FIG. 12 and FIGS. 13A, 13B and 13C, or equivalent systems, including but not limited to: Ethernet (or IEEE 802.3), UART, USB, SAP, SAS™, SuperSAS™, ATP, Bluetooth, TCP/IP, Token Ring, cable, satellite, or via any appropriate communications protocol or combination of communications protocols. Further, in some embodiments, various communications protocols endorsed by the Gaming Standards Association (Fremont, Calif.), may be utilized, such as (i) the Gaming Device Standard (GDS), which may facilitate communication between a gaming device and various component devices and/or peripheral devices (e.g., printers, bill acceptors, etc.), (ii) the Best of Breed (BOB) standard, which may facilitate communication between a gaming device and various servers related to play of one or more gaming devices (e.g., servers that assist in providing accounting, player tracking, ticket-in/ticket-out and progressive jackpot functionality), and/or (iii) the System-to-System (S2S) standard, which may facilitate communication between game-related servers and/or casino property management servers (e.g., a hotel server comprising one or more databases that store information about booking and reservations). Transmissions and records may be encrypted to ensure privacy and prevent fraud in any of a variety of ways known in the art.

Each of the gaming devices 132a, 132b, 132c, and 132d, may comprise a processor having functionalities and peripheral devices described in FIG. 12, and may be adapted to communicate with server 130, with one or more remote computing facilities via a cloud connection (122), or generally in peer-to-peer networks. The gaming devices need not be stationary to be networked; as suggested figuratively with dashed arrows indicating mobile devices in FIG. 13B, mobile devices having capacity for gameplay are frequently linked via a cloud-based Internet or in a LAN operated network (136a) at 2.5 GHz or 5 GHz over short distances or over a cellular phone network, and some or all of the game content may be remotely supplied to the mobile devices. In one instance, gaming systems 132a, 132b, 132c and 132d are coordinated from a cloud-based facility via a wireless communications protocol (136a). In other instances, as shown in FIG. 13C, gaming systems 132a, 132b, 132c and 132d may communicate directly with each other in a LAN or mesh network (136b) while also communicating with a server 130. Any number and type of gaming devices may be in communication in a computerized network.

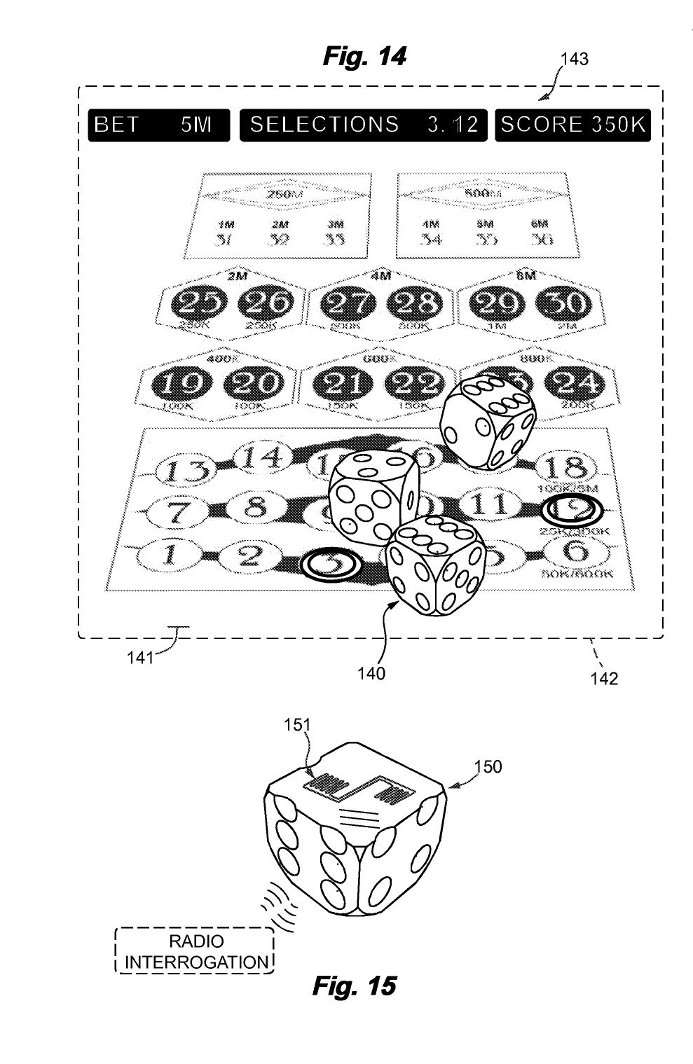

Some players prefer the physical feel of throwing the dice. Thus in other variants of the games described here, the dice may be rolled manually. But if the games are played on a physical gameboard instead of an electronic device, play may be slow. In one improved system, dice rolled manually are entered onto an electronic gameboard as an aid in scoring. A hybrid game can be modelled and played on a real surface with real dice 140, but with a computerized shell that projects the gameboard onto the surface and reads the dice face values. FIG. 14 is a perspective view of a graphical display in which tactile dice are physically thrown on a virtual gameboard 141 displayed on a computer tablet 142 and are read by the gaming system electronically or optically. An electronic tally board, bet tracker, and scoring display 143 is included. Hybrid virtual gameplay speeds up the game and eases scorekeeping, allowing a player to focus on the enjoyment of feeling and throwing real dice. Thus in another embodiment, the invention is a hybrid system for playing a dice game on a gameboard with real dice, including either keypad entry or sensors for recognizing dice face values after a dice roll, and a processor with instructions in non-volatile memory for game management and automatic scoring.

FIG. 15 is a perspective view of a dice cube 150 with exposed section, the section revealing an internal embedded RFID antenna 151. In these variants of the invention, three to five tangible dice cubes are provided to the player, and the results of an actual dice roll are received by the gaming system directly or indirectly from the dice cubes via radio interrogation. In one example, radio interrogation is used to detect dice faces according to an RFID antennae embedded in the dice cubes. Advantageously, use of RFID sensors in the cubes will prevent players from substituting loaded dice from their pockets and, with development, RFID technology using oriented loops under the surface of the dice member is a promising method for detecting the dice position from a remote antenna. Alternatively, small antennae may be mounted in associating with each pip, the dice body having a dielectric electromagnetic resistance that limits the return signal to either the top face or the bottom face. Each frequency determines a particular pip or pip combination.

In another working system, a laser reader is used to scan the dice after the throw and the data from bar codes or QR codes are used to look up the dice face values. Alternatively the face up position of the dice cubes at rest may be captured by image analysis software such as is used in manufacturing, or may be sensed using a combination of accelerometers and magnetometers or capacitive sensors embedded in the dice. Some of these dice are internally powered and include for example a Bluetooth or Manet LAN device for wirelessly communicating the dice roll outcome to a local processor of the gaming system based on internal sensors that are gravimetrically calibrated.

Alternatively, in another inventive gaming system, the stage “floor” for throwing the dice is fitted with a network of microsensors such as LEDs, hall effect sensors, or piezoelectric strain gauges that can recognize the face-down pips of a dice cube face and from that data can use a look-up table to determine the corresponding face-up face value. A stage made of LEDs can be interrogated electronically to determine a white reflective surface of the dice cube body enclosing a pattern of non-reflective black pips, or vice versa, very much as a television set displays an image, but in reverse as a way of sensing patterns in objects. Such an optical surface is rugged and durable and can be readily verified and calibrated to ensure that the dice roll outcomes are unbiased. The results of the dice roll are read or displayed to the player, and will be recorded on the gaming system's user interface, providing an immediate check that can be flagged for the game operator. Video monitors mounted in the gaming system are used to ensure that players do not falsely cry foul and any suspect outcomes are subject to an instant replay.

Alternatively, plastic dice bodies for example can be modified during injection molding with a powdered magnetic filler so that the pips are sensed as a disparity in what otherwise lights up in a field of solid state Hall Effect sensors in the stage when proximate to the dice body. These are technological features of the gaming systems that are advances in the art, and further serve to break down the barriers in the user interface between the real world, the virtual world, and the internet of things, so that the player can enjoy the advantages of both feeling the throw of the dice and the digital speed of gameplay facilitated by a computerized machine. Smart interfaces will also sense the gestural language used by the player in throwing the dice. Use of actual dice is favored by a number of players and a further object of the invention is to provide a game that can be played quickly, either by using virtual dice, or by having a transducer that senses the dice position and enters the outcome of the dice roll automatically.

Then within the processor, matrix manipulations and calculations based on each dice outcome are used to display play options, receive allowed player selections, calculate scores, update the board configuration, eliminating any numbered positions that are eliminated, detect game ending conditions, and so forth.

Envisaged are systems for operating a hybrid virtual dice elimination game of chance, which comprise an electronic stage with a gameboard having markings for multiple zones and numbered selectable positions, multiple dice; and a set of programmable rules executable by a processor for playing and scoring the game. The system may be configured to electronically or optically detect the dice face values of a dice throw. One such system may include dice cubes that are in electronic communication with a computing device configured to score the game.

In other variants of the games, dice members having more than six faces may be used. Dice members having octahedral, dodecahedral, and icosahedral morphology are known in gaming arts. In a preferred system, the dice are dice icosahedrons. The dice icosahedrons are in electronic communication with a computing device configured to score the game, the computing device comprising a) a non-volatile memory device, wherein the non-volatile memory device is configured to store digitally-encoded instructions to perform a method; b) a processor digitally coupled to the non-volatile memory device, wherein the processor is configured to execute the instructions; c) a player interface operatively coupled to the processor, wherein the player interface is configured to receive inputs from the electronic and to display a game state according to the instructions.

In yet another variant, an electronic system for use with icosahedral dice may employ a gameboard having markings for three or more zones and seventy two or more numbered positions, wherein a first zone is bounded at 36, a second zone is bounded at 60, and a third zone is bounded at 72 or higher, for example. The system may use virtual or tactile icosahedral dice, including for example three white dice, two black dice, and one golden die. The gameboard or stage may be configured is to electronically or optically detect the dice face values of a dice throw.

The above disclosure is sufficient to enable one of ordinary skill in the art to practice the invention, and provides the best mode of practicing the invention presently contemplated by the inventor. While above is a complete description of the preferred embodiments of the present invention, various alternatives, modifications and equivalents are possible. These embodiments, alternatives, modifications and equivalents may be combined to provide further embodiments of the present invention. Further, all foreign and/or domestic publications, patents, and patent applications cited herein, whether supra or infra, are hereby incorporated by reference in their entirety for all they teach. The inventions, examples, and embodiments described herein are not limited to particularly exemplified materials, methods, and/or structures. Various modifications, alternative constructions, changes and equivalents will readily occur to those skilled in the art and may be employed, as suitable, without departing from the true spirit and scope of the invention. Therefore, the above description and illustrations should not be construed as limiting the scope of the invention, which is defined by the appended claims.

### INCORPORATION BY REFERENCE

All of the US Patents, US Patent Applications, US Patent application publications, foreign patents, foreign patent applications and non-patent publications referred to in this specification and related filings are incorporated herein by reference in their entirety.

### SCOPE OF CLAIMS

Having described the invention with reference to the exemplary embodiments, it is to be understood that it is not intended that any limitations or elements describing the exemplary embodiments set forth herein are to be incorporated into the meanings of the patent claims unless such limitations or elements are explicitly listed in the claims. Likewise, it is to be understood that it is not necessary to meet any or all of the identified advantages or objects of the invention disclose herein in order to fall within the scope of any claims, since the invention is defined by the claims and inherent and/or unforeseen advantages of the present invention may exist even though they may not be explicitly discussed herein.

While the above is a complete description of selected, currently preferred embodiments of the present invention, it is possible to practice the invention use various alternatives, modifications, combinations and equivalents. In general, in the following claims, the terms used in the written description should not be construed to limit the claims to specific embodiments described herein for illustration, but should be construed to include all possible embodiments, both specific and generic, along with the full scope of equivalents to which such claims are entitled. Accordingly, the claims are not limited by the disclosure.

### REFERENCE NUMBERS OF THE DRAWINGS

10 ZONE ONE
11 Numbered positions 1 through 18
12 Three white dice
20 ZONE TWO
21 Numbered positions 19 through 30
22 Extra score for pairs eliminated
23 Score per position eliminated in ZONE TWO
24 Two black dice
30 ZONE THREE
31 Numbered positions 31 through 36
32 One gold die
80 Simplified gameboard
90 Enhanced virtual gaming surface with dice roll animation
91 Extra point scoring utility
92a,b,c Three simulated dice
93 Triple bonus indicator
99 PASS-ROLL soft button
100 Computerized gaming system
101 Video screen with display of virtual gameboard
102 Logo display screen
103 User analog controls
104 Coin tray or bin
105 Card, token or ticket acceptor and dispenser
106 Supplementary display screen
110 Schematic view of a gaming system or platform
111 Processor
112 ROM memory, generically
113 RAM memory, generically, including flash drive/hard drive families
114 Memory utility
115 Video display
116 Touch screen feature
117 Tactilographical display panel
118 Touch screen controller
119 Video controller
120 Accessory input devices
121 Accessory displays
122 Cloud based connectivity feature
123 Digital fiber optic connection
124 Speakers
125 Audio controller
126 Payment acceptor
128 Network communications device
130 Local server
132a-d Gaming systems
134 Hardwired network
136a Wireless network
136b Wireless mesh network
140 Tactile dice cubes
141 Virtual gameboard
142 Tablet computer with gaming system
143 Player's tally windows
150 Dice cube in section view
151 Embedded RFID antenna

I claim:

1. A system for operating a virtual dice elimination game of chance, which comprises:
a) a non-volatile memory device, wherein said non-volatile memory device is configured to store digitally-encoded instructions to perform a method;
b) a processor digitally coupled to said non-volatile memory device, wherein said processor is configured to execute said instructions;
c) a player interface operatively coupled to said processor, wherein said player interface is configured to receive inputs from a player and to display a game state according to said instructions;
d) wherein said method comprises:
(i) starting a game by displaying an initial game state on said player interface, said initial game state comprising a virtual gameboard having three zones, a first zone having selectable positions designated by numbers 1 through X, a second zone having selectable positions designated by numbers X+1 through Y, and a third zone having selectable positions designated by numbers Y+1 through Z, wherein all selectable positions are open for play;
(ii) executing a dice throw upon receiving a signal from a player, wherein one or more virtual dice are thrown, and displaying a set of randomized dice face values having one face value for each dice thrown;
(iii) for elimination, receiving from a player a selection or selections of any selectable position or positions having a number corresponding to either one dice face value or an addition of dice face values from said set, clearing any dice face values that result in an elimination until no dice face values are left in said set, and displaying an updated game state differentiating selectable positions on said gameboard that are either open for play or closed by an elimination;
(iv) iterating steps (i), (ii) and (iii) until no further eliminations of selectable positions open for play are possible based on said set of dice face values thrown; and,
(v) displaying on said player interface a final game state showing any dice face values not cleared and a game score based on all said eliminations from steps (iii) and (iv).

2. The system of claim 1, further comprising a device configured to receive a bet when starting a game; resolve said bet when ending a game, and conditionally making an award to a player based on said score, wherein said device is operatively coupled to said processor.

3. The system of claim 1, wherein said digitally-encoded instructions to perform a method further comprise programmable instructions selected from:
(a) beginning gameplay by rolling a three dice cubes and eliminating at least one numbered position in said first zone;
(b) conditioning gameplay such that if a numbered position is eliminated, it is not available for further selection;
(c) ending gameplay if any dice roll results in a trap condition in which at least one the dice face values of said set cannot be used to select an elimination, further wherein each dice face value of a dice roll is used once and only once;
(d) continuing game play by rolling three dice cubes and eliminating any dice cube values in said first zone until the sum of the three face values thrown is greater than X, then rolling only two dice cubes and selecting for elimination at least one numbered position in said second zone corresponding to the addition of the highest elimination value in the first zone from preceding play and a face value of one or both of said two dice cubes as rolled;
(e) conditioning gameplay such that if said summation from step (d) is greater than Y, then rolling only one dice cube and selecting for elimination one numbered position in said third zone corresponding to the addition of the highest elimination value in the second zone from preceding play to the face value of said one dice cube as rolled;
(f) conditioning gameplay by continuing as in step (ii) if any roll of two dice does not result in a roll of a single dice, or if any roll of a single dice results in an elimination in zone three;
(g) after any roll of three dice which results in a triple, triggering an automatic extra roll of three dice;
(h) conditioned on encountering a game state such that no further elimination of selectable positions open for play is possible, summing all the numbered positions eliminated during play and displaying a score derived therefrom; or,
(i) conditioned on encountering a game state such that no further elimination of selectable positions open for play is possible, determining the highest number eliminated in each zone and displaying a game score with any associated incentive or award.

4. The system of claim 1, wherein a value is assigned to each numbered position prior to the start of the game, and said score is a sum of said values for each numbered position eliminated.

5. The system of claim 4, further comprising a score tally board or indicator providing a running total of said score for all selectable positions that have been eliminated.

6. The system of claim 4, wherein an elimination of a numbered position is indicated by highlighting said position, by darkening said position, or by deleting said position on said virtual gameboard.

7. The system of claim 1, further comprising a digital connection between said processor and a network.

8. The system of claim 7, wherein said player interface is configured to be accessible to a player via an online web site.

9. The system of claim 7, wherein said player interface is configured to be accessible to a player on a cell phone, a computing machine, or a mobile device.

10. The system of claim 1, wherein said system is a casino gaming machine.

11. The system of claim 1, further comprising a graphics rendering engine or daemon configured to animate said virtual dice of a dice throw.

12. The system of claim 11, wherein said graphics rendering engine or daemon is operatively coupled to a random number generator.

13. The system of claim 12, wherein said random number generator is non-deterministic.

14. The system of claim 13, wherein said random number generator is a true random number generator or a kinematic random number generator.

15. The system of claim 1, wherein said X=18, Y=30 and Z=36.
